(19) United States
(12) Patent Application Publication
(10) Pub. No.: US 2008/0155868 A1
(43) Pub. Date: Jul. 3, 2008

(54) TOOTHBRUSH WITH TIME INDICIA

(76) Inventor: Sergio DeGennaro, Westbury, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/619,438

(22) Filed: Jan. 3, 2007

(51) Int. Cl. G09F 3/00

(52) U.S. Cl. 40/314

(57) ABSTRACT

A toothbrush, toothbrush tip or plurality of either in which an intended time period of use is marked on the brush. The marking informs the user of the toothbrush when to begin using that toothbrush, when to stop using that toothbrush, or both.

### FIELD OF THE INVENTION

The present invention relates to dental care products and more particularly to a new and improved technique for aiding a consumer to properly replace his or her toothbrush.

### BACKGROUND OF THE INVENTION

Many innovations have arisen in the field of dental care including bent handles to reach hard to access teeth, vibrating brushes to better remove plaque, and various bristle formation patterns, also to better remove plaque.

But to ensure proper dental hygiene, replacing a toothbrush can be even more important than the various advances listed above. As a toothbrush is used, numerous problems occur. First, remnant food from a person's mouth can become attached to the bristles during brushing. In addition, bacteria naturally present in a person's mouth will also become attached to the bristles. The bacteria will reproduce and grow on the bristles during the time between brushing, creating a less sanitary toothbrush. Second, the brushing action can create stress on the bristles and force some bristles to become dislodged. Over time, as bristles become dislodged, the toothbrush becomes less effective. Third, the brushing action bends and otherwise disfigures the bristles. In many cases, the bristles are no longer parallel to each other and no longer point in the proper direction. Fourth, the brushing action weakens and decreases the general firmness of the bristles.

The problem of toothbrush replacement is one that has been known for some time. U.S. Pat. No. 4,466,150 discusses the problem and provides a toothbrush that allows the user to indicate the date he or she began to use it. But this method is not fully effective in that it requires the user to take action to mark the toothbrush, and it does not readily remind the user to change the brush.

### SUMMARY OF THE INVENTION

The present invention aims to provide a new method for aiding a user in replacing his or her toothbrush. The present invention provides a means for indicating the time period during which a particular toothbrush should be used. Indicia or labels affixed to the toothbrush indicate a particular time period of use, most simply a particular month.

### BRIEF DESCRIPTION OF THE FIGURES

To further satisfy the recited objectives, a detailed description of typical embodiments of the invention is provided with reference to appended drawings that are not intended to limit the scope of the invention, in which:

FIG. 1 is a perspective view of one embodiment of the present invention;

FIG. 2 is a perspective view of a package consistent with the embodiment of FIG. 1;

FIG. 3 is a perspective view of a second embodiment of the present invention.

### DESCRIPTION OF THE INVENTION

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by this description. All changes that come within the meaning and range of equivalency of the claims are to be embraced within their scope.

The present invention provides a means for dealing with the problems associated with the failure to timely replace the bristle portion of a toothbrush. The problem arises, not because of the difficulty a user encounters in switching to a new brush, but the difficulty the user encounters in remembering that he or she has to switch. The present invention provides a constant reminder of whether or not the toothbrush should be replaced. In order to best avoid the above-mentioned problems associated with an overused brush, dentists recommend replacing the brush every one to three months. The simplest way to identify when a month has passed is to begin using a brush on the first of a given month and then replace that brush on the first of the next month, or the first of either the second or third next month. For that reason, the present invention labels each toothbrush with a given month. Alternatively, the brush can be labeled with a two-month period (e.g., January-February; Jan-Feb) or a three-month period (e.g., April-June; Apr-Jun). In any case, the label or indicia must be such that an average person can read it without difficulty.

The time indicia is present to inform the user when to begin using a particular toothbrush, when to stop using a particular toothbrush or even both. In the embodiment where a single month, such as “July”, is marked on the toothbrush, the user will infer from the marking that he or she should begin to use the toothbrush at the beginning of July and stop using the toothbrush at the end of July. Alternatively, it is consistent with this invention to label brushes with indicia such as “July-August” indicating that the user should use the toothbrush for two months.

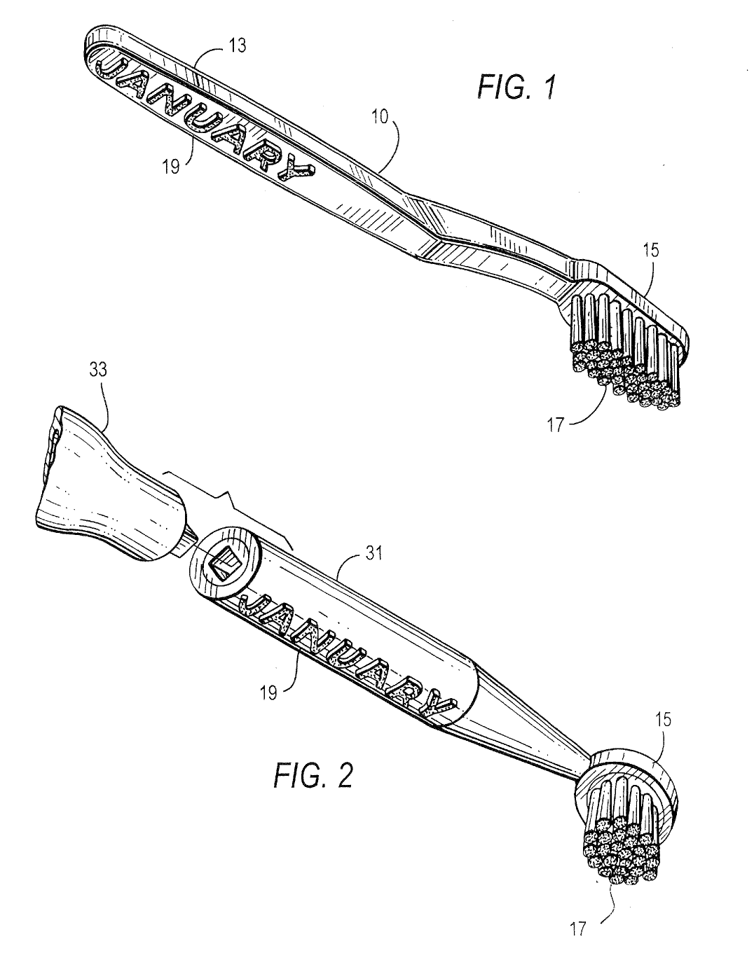

FIG. 1 of the present invention shows a standard toothbrush 10 including a handle 13, head 15, and bristles 17, with a label 19 affixed to the handle. The label indicates the month(s) of the year for which the toothbrush is to be used. In FIG. 1, the month January is used as an example. The label 19, can be applied in numerous different ways, including but not limited to the use of a sticker, ink, or paint, or being molded as part of the toothbrush structure itself. The toothbrush 10 is preferably constructed of plastic, but can be formed of any material that is proper for use in a person's mouth.

FIG. 2 of the present invention shows a toothbrush tip 31 meant to be used with a permanent toothbrush base 33. Preferably the base 33 creates vibration action in the tip 31 by use of an electric motor in the base. The toothbrush tip 31 is labeled with a particular month as described above.

This embodiment of the brush is in the form of a tip for the purpose of having the tip attach to a handle that does not need to be replaced on a regular basis. Dentists are discovering that there are significant benefits that come with using a mechanical toothbrush that creates its own vibration or rotation action. Generally speaking, the permanent mechanical handle will have an extension that connects with the tip in a manner to allow the vibration or rotation created in the handle to be transferred into the tip.

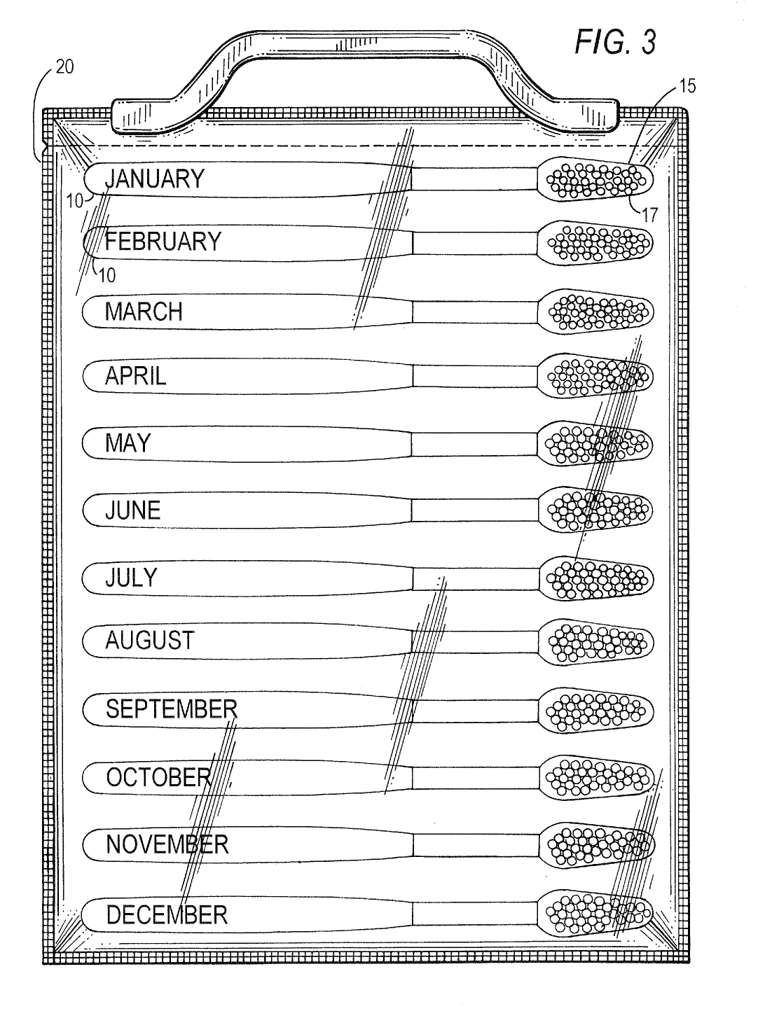

FIG. 3 shows a package 20 of twelve standard toothbrushes, each being labeled with a different month. The individual brushes 10 are substantially the same as that shown in FIG. 1 and described above. The package is preferably a blister pack, but can be any package that protects the bristles from being damaged prior to the user opening the package.

The package shown in FIG. 3 contains twelve toothbrushes to account for the twelve months of the year. The user is provided a new toothbrush for each month. This way the user knows both when to begin to use a certain toothbrush and when to dispose of that toothbrush and begin to use a new one. This will prevent the problems associated with using a toothbrush for too long described earlier. Alternative embodiments involve a package of six brushes, where each is labeled for two months, or a package of four brushes, where each brush is labeled for three months.

Although the invention has been described with reference to a particular embodiments, it is to be understood that these embodiments are merely illustrative of the application of the principles of the invention. Numerous modifications may be made therein and other arrangements may be devised without departing from the spirit and scope of the invention.

What is claimed is:

1. A toothbrush comprising:
an elongated handle with a head at one end;
said head having attached to it a plurality of bristles; and
indicia on said handle that represent a time period of intended use of the toothbrush.

2. The toothbrush of claim 1 wherein said elongated handle is attachable to a motorized base.

3. The toothbrush of claim 1 wherein said indicia indicate a month or combination of months.

4. The toothbrush of claim 2 wherein said indicia indicates a month or combination of months.

5. A package of toothbrushes comprising:
a plurality of toothbrushes;
wherein each toothbrush comprises an elongated handle, which is attached to a head at one end;
said head having attached to it, a plurality of bristles; and
indicia on said handle that represent a time period of intended use of the toothbrush.

6. The package of toothbrushes of claim 5 wherein said indicia indicate a month or combination of months.

7. The package of toothbrushes of claim 5 wherein:
the elongated handle of each toothbrush connects to a motorized handle.

8. The package of toothbrushes of claim 7 wherein said indicia indicate a month or combination of months.
